(19) United States
(12) Patent Application Publication
(10) Pub. No.: US 2009/0129852 A1
(43) Pub. Date: May 21, 2009

(54) LEVEL COMPENSATION PLATE

(75) Inventors: Boris Koch, Wermelskirchen (DE); Harald Becher, Reichertshofen (DE); Jacques Hoffner, Saint-Amarin (FR)

Correspondence Address: NORRIS, MCLAUGHLIN & MARCUS, P.A., 875 THIRD AVE, 18TH FLOOR, NEW YORK, NY, 10022, US

(73) Assignees: LANXESS DEUTSCHLAND GMBH, Leverkusen (DE); FAURECIA KUNSTSTOFFE AUTOMOBILSYSTEME GMBH, Ingolstadt (DE)

(21) Appl. No.: 11/916,385

(22) PCT Filed: Jun. 17, 2006
(86) PCT No.: PCT/EP2006/005827

§ 371 Date: Oct. 14, 2008

(30) Foreign Application Priority Data
Jun. 28, 2005 (DE) 10 2005 029 952.0

(51) Int. Cl. F16B 5/02

(52) U.S. Cl. 403/4

(57) ABSTRACT

Device for the stress-free fixing of one or more components to a carrier part, to align the edges or surfaces of the component or components in an exactly determined position in relation to the carrier or to adjacent components and to compensate for fabrication and mounting tolerances of the component or components to the greatest possible extent.

The invention relates to a device for the stress-free fixing of one or more components to a carrier part, the intention being for the edges or surfaces of the component or components to be in an exactly determined position in relation to the carrier or adjacent components and to compensate for fabrication and mounting tolerances of the component or components to the greatest possible extent.

The invention relates further to the use of such devices for fixing housings, housings plus lids, headlamps, headlamp housings, in particular in motor vehicle technology, to module carriers or front ends.

A fixing device for bridging fabrication or mounting tolerances is already known from EP 1 200 745 B1. However, EP 1 200 745 B1 describes a device for the stressed connections of components located at a distance from one another by means of a spacer arranged in the space and a clamping piece stressing the two components against each other, the fixing actuation of the clamping piece firstly displacing the first component from a spaced-apart position to a contact position in relation to the second component and then the device being fixed to the first component by means of spreading elements resting against the wall of a plug-in hollow in the first component and the spreading elements being arranged on the spacer.

Although this fixing device is also a fixing means with simultaneous compensation for tolerances, it is a fixing device which is used in addition to a normal screw connection. In this case, the adjusting element is placed between the fixing lug of the housing and the carrier. The adjusting element automatically corrects the tolerances of the fixing lugs as they are screwed up. The adjusting element additionally comprises a plurality of individual parts, which have to be fabricated precisely. A further disadvantage is that the adjusting element exerts a certain force on the fixing lugs because of its construction and thus, in specific cases, it is possible for displacement of the intended component position to occur.

There was therefore the need to develop a fixing system which can be produced simply and which functions without additional working, mounting or adjusting steps, that is to say which adapts automatically to a specific installation situation of a housing, transmits no stress to the housing and thus guarantees fault-free, precise fixing.

The subject of the present invention and thus the solution to the object is a fixing device for the stress-free fixing of one or more components (e.g. housing, housing plus lid, headlamp, headlamp housing) to a carrier part (e.g. module carrier, front end), the intention being for the edges or surfaces of the component or components to be in an exactly determined position in relation to the carrier or to adjacent components and to compensate for fabrication and mounting tolerances of the component or components to the greatest possible extent, characterized in that, by means of two lugs which are flexible or mounted in an articulated manner at their respective ends and which are located on a carrier part, stress-free compensation of tolerances between any desired positioning point on a component to be fixed or a subassembly to be fixed and the actual fixing lug on the component itself is made possible, the position of the component/of the subassembly in relation to the carrier part is determined via three reference surfaces, a concentric hole and a slot, and the lugs on the carrier part adapt automatically to the level of the fixing lugs during the connection of the connecting point, which means that, after the two carrier lugs have been connected to the component lug(s) located between them and as a result of the arrangement of the lugs in relation to one another, a rigid connection is produced between component or subassembly and carrier part without changing the position of the component or the subassembly in relation to the carrier part.

In comparison with fixing systems from the prior art, the fixing device according to the invention needs no additional elements apart from the actual connecting element/s, is simple to produce, simple and fault-free in handling and is distinguished by high rigidity and load-bearing ability. The fixing device according to the invention is therefore excellently well suited to the stress-free fixing of components to carrier parts, in particular where relatively large fabrication or mounting tolerances occur as a result of the fabrication, for example in the building industry, furniture industry, in railway wagon construction, vehicle construction, ship construction, aircraft construction or spacecraft construction.

By means of the fixing device according to the invention, components of an extremely wide range of materials can be connected without stress to carrier parts of the same material or different materials. Suitable materials in this case are thermoplastic and thermosetting plastics, polyurethanes, metals, for example steel, aluminium, magnesium.

The flexible lugs fixed to the carrier part should preferably be fabricated from polymer materials. Use is preferably made of lugs which are obtained by injection moulding processes or pressing processes from thermoplastic or thermosetting plastics, for example polyethylene, polypropylene, polyamide, polyester or epoxy resins or polyurethanes.

The fixing of the component/the subassembly via the fixing lugs is carried out at the flexible lugs (which are connected to the carrier part). The connection itself is made by means of one or more connecting elements, preferably screws or rivets.

The low relative movement at right angles to the direction of movement of the flexible lugs during connection is compensated for by means of relatively large drilled holes or square holes (with respect to the screw or rivet diameters) on the fixing lugs of the component/the subassembly.

The position of the component in relation to the carrier part is determined by three reference surfaces, a concentric hole and by a slot on the component. Likewise, there are three reference surfaces and two concentric pins on the carrier part. In order to position the component in relation to the carrier part, the reference surfaces and the pins and holes are made to overlap. The carrier lugs are then screwed or riveted to the component lug(s) located between them.

After the carrier lugs have been connected to the component lug(s) located between them, and as a result of the arrangement of the lugs in relation to one another, a rigid connection is produced between component(s) and carrier part. This rigid connection can either be made on the principle of a three-bar linkage or on the principle of a four-bar linkage. In the case of the connection on the principle of a three-bar linkage, a three-bar linkage is produced by closing the free ends of two lugs that are flexible or mounted in an articulated manner on a carrier part and whose common connection point is immovable. In the case of the connection on the principle of a four-bar linkage, a four-bar linkage is produced by closing the free ends of two lugs on a carrier part that are flexible or mounted in an articulated manner at their respective ends and whose common connecting point can move to a restricted extent. By using at least three four-bar linkage systems in space, it being necessary for the third four-bar linkage to be rotated through 90° in relation to four-bar linkage 1 and 2, a system whose connecting points are immovable is produced.

Exemplary embodiments of the invention will be explained below by using appended drawings, in which:

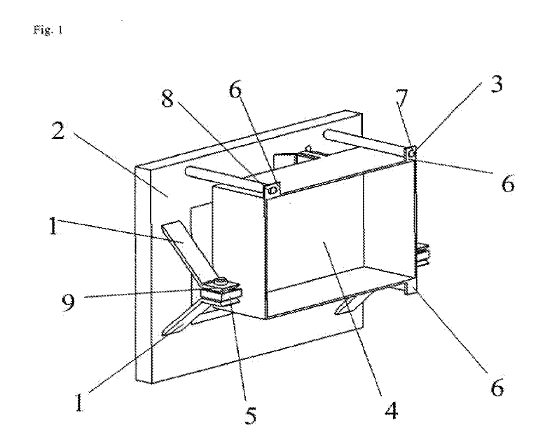

FIG. 1 shows an exemplary overall illustration of the fixing device according to the invention using the example of a box-shaped component (4) on a flat carrier part (2).

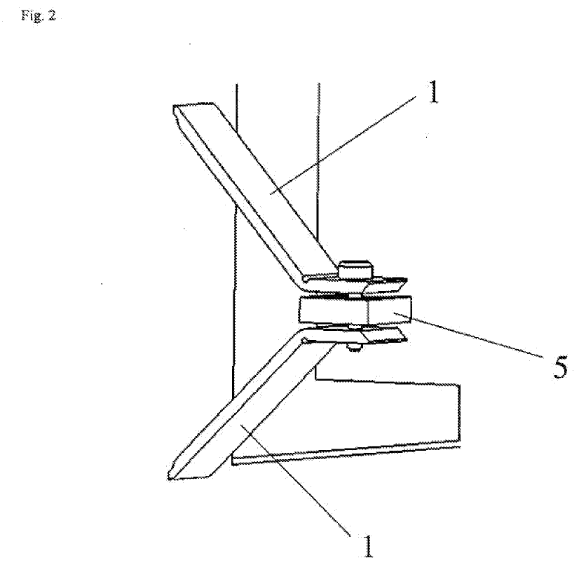

FIG. 2 shows two lugs of a carrier part (not shown) which are connected to a component (only the frame can be seen) via a component lug (5).

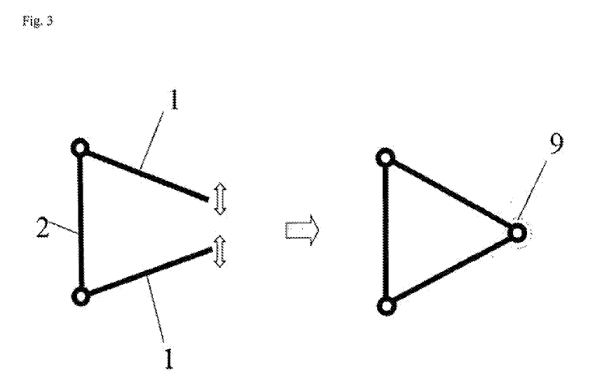

FIG. 3 shows the principle of the double lug: variant 1, three-bar linkage.

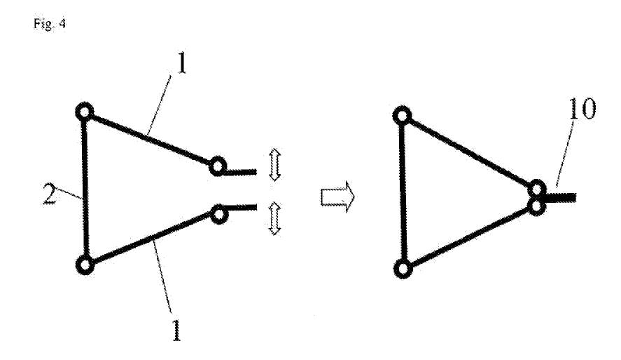

FIG. 4 shows the principle of the double lug: variant 2, four-bar linkage.

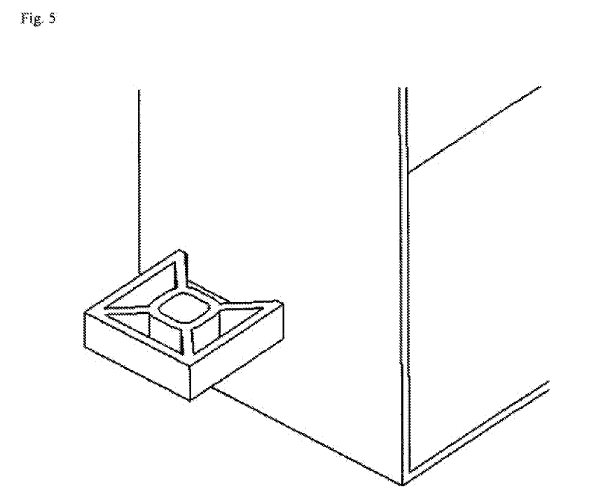

FIG. 5 shows an example of a fixing lug with a square hole on the component.

FIG. 1 reveals an exemplary overall illustration of the fixing device according to the invention, characterized in that, by means of two lugs (1) which are flexible or mounted in an articulated manner at their respective ends and which are located on a carrier part (2), stress-free compensation of tolerances between any desired positioning point (3) on a component (4) or a subassembly and the actual fixing lug (5) on the component (4) is made possible. The position of the component in relation to the carrier is determined via three reference surfaces (6), a concentric hole (7) and a slot (8). This yields the position of the component (4) and the fixing lugs (5) present on the component. The lugs (1) on the carrier adapt automatically to the level of the fixing lugs (5) on the component (4) during the connection, preferably the screw fixing, of the connecting point. Following the connection or the screw fixing of the two carrier lugs (1) with the component lug located between them, and as a result of the arrangement of the lugs (1) in relation to one another on the principle of the three-bar linkage or a plurality of four-bar linkages, a rigid connection between component/s and carrier part is produced, in particular when three fixing points are used, without changing the position of the component in relation to the carrier part.

### Variant 1: Three-Bar Linkage

By closing the free ends of two lugs (1) which are flexible or mounted in an articulated manner on a carrier (2), a three-bar linkage is produced whose common connecting point (9) is immovable.

### Variant 2: Four-Bar Linkage

By closing the free ends of two lugs (1) which are flexible or mounted in an articulated manner at their respective ends on a carrier (2), a four-bar linkage is produced whose common connecting point (10) can move to a restricted extent.

By using at least two four-bar linkage systems in the plane or three four-bar linkage systems in space, it being necessary for the four-bar linkage 3 to be rotated through 90° in relation to four-bar linkage 1 and 2, a system whose connecting points (10) are immovable is produced.

1. Fixing device for the stress-free fixing of one or more components to a carrier part, the edges or surfaces of the component or components being in an exactly determined position in relation to the carrier or adjacent components and fabrication and mounting tolerances of the component or components being at least partially compensated for wherein, by means of two lugs which are flexible or mounted in an articulated manner at their respective ends and which are located on a carrier part, stress-free compensation of tolerances between any desired positioning point on a component to be fixed or a subassembly to be fixed and the actual fixing lug on the component itself is made possible, the position of the component/of the subassembly in relation to the carrier part is determined via three reference surfaces, a concentric hole and a slot, and the lugs on the carrier part adapt automatically to the level of the fixing lugs during the connection of the connecting point, whereby, after the two carrier lugs have been connected to the component lug(s) located between them and as a result of the arrangement of the lugs in relation to one another, a rigid connection is produced between component or subassembly and carrier part without changing the position of the component or the subassembly in relation to the carrier part.

2. Fixing device according to claim 1, wherein the lugs, which are flexible or mounted in an articulated manner at their respective ends, are fabricated from flexible materials.

3. Fixing device according to claim 1, wherein the rigid connection between component(s) and carrier part is made on the principle of a three-bar linkage.

4. Fixing device according to claim 1, wherein the rigid connection between component(s) and carrier part is includes a four-bar linkage.

5. Method for the stress-free fixing of components to carrier parts, which comprises fixing said components to said carrier parts with the fixing device of claim 1.

6. Method of claim 5, wherein the components are fixed to carrier parts where fabrication or mounting tolerances occur as a result of the fabrication.
